(19) United States
(12) Patent Application Publication
(10) Pub. No.: US 2024/0245942 A1
(43) Pub. Date: Jul. 25, 2024

(54) METHODS AND SYSTEMS FOR EXTINGUISHING FIRES

(71) Applicant: PYRONEMESIS, INC., Boulder, CO (US)

(72) Inventor: Stephen Wolf, Longmont, CO (US)

(73) Assignee: Team Wildfire Inc., Longmont, CO (US)

(21) Appl. No.: 18/561,972

(22) PCT Filed: May 16, 2022
(86) PCT No.: PCT/US2022/029454

§ 371 Date: Nov. 17, 2023

Related U.S. Application Data
(60) Provisional application No. 63/189,463, filed on May 17, 2021.

(51) Int. Cl. A62C 3/02; A62C 27/00

(52) U.S. Cl. CPC A62C 3/0207; A62C 3/0292; A62C 27/00

(57) ABSTRACT

A fluid projecting platform comprising: a vehicle; a primary fluid projectile vessel configured to store a primary fluid projectile; a secondar fluid projectile vessel configured to store a secondary fluid; a tertiary fluid projectile vessel configured to store a tertiary fluid projectile; a first nozzle; a second nozzle; a first pump fluidically transmitting the primary fluid projectile to the first nozzle; a second pump fluidically transmitting the secondary fluid projectile to the first nozzle; a third pump fluidically transmitting the tertiary fluid projectile to the second nozzle; an air compressor providing compressed air to the second nozzle; a jet engine emitting a jet-stream of a gas in a direction non-coincident with an output of the first nozzle; a gimbal arm having a first end coupled to the vehicle, and having a second end couple to the jet engine.

### CROSS-REFERENCE

This application claims the benefit of U.S. Provisional Application No. 63/189,463, filed May 17, 2021, which is hereby incorporated by reference in its entirety herein.

### BACKGROUND

Every year millions of acres of land are destroyed due to wildfires. In two of the past five years, wildfire destruction surpassed 10 million acres. Some years have seen the loss of over 40 million acres. Wildfire related loss of homes, farms, vehicles, animal, and human life have all increased recently, due to drought, pest infestation, and climatic change.

Recent raging bush wildfires in Australia killed 200 people, destroyed 750 homes, left 5,000 people homeless, and burned 1,100 square miles of land. Fires this year in California and Colorado have consumed millions of acres, hundreds of homes, and are indicative of what we can expect as climate conditions change to favor more wildfire.

Droughts, lightning strikes, smoldering campfires, and accidents continue to occur, and fire service agencies are ill equipped to contend with high winds, dust, debris, and rough terrain. Typically, human effort is the norm in defeating fires in remote regions such as the Grand Canyon, the Everglades, and hilly communities in California, Colorado, and Texas. Current methods and scientific solutions leave fire departments with dated equipment and chemistries that often fail to control terrain fires.

Existing approaches such as aircraft/helicopters dropping extinguishment chemicals inefficiently fail to hit key zones, are costly, subject to availability, vulnerable to weather conditions, and can be toxic and polluting. Smokejumpers, National Guard, and local fire departments personnel and equipment are no match for raging fires. Typically, backpack water/foam tanks are used by volunteer firefighters who are routinely overcome by fatigue and smoke inhalation, and all too tragically burned to death.

The use of municipal fire trucks, brush trucks, and common firefighting apparatus fails to reach areas which lack roads, and are incapable of penetrating fires. Controlling intense fires require rapid deployment of specialized equipment and a minimum of labor.

### SUMMARY

One aspect provided herein is a fluid projecting platform comprising: a vehicle; a primary fluid projectile vessel configured to store a primary fluid projectile; a secondary fluid projectile vessel configured to store a secondary fluid; a tertiary fluid projectile vessel configured to store a tertiary fluid projectile; a first nozzle; a second nozzle; a first pump fluidically transmitting the primary fluid projectile to the first nozzle; a second pump fluidically transmitting the secondary fluid projectile to the first nozzle; a third pump fluidically transmitting the tertiary fluid projectile to the second nozzle; an air compressor providing compressed air to the second nozzle; a jet engine emitting a jet-stream of a gas in a direction non-coincident with an output of the first nozzle; a gimbal arm having a first end coupled to the vehicle, and having a second end coupled to the jet engine, wherein the gimbal arm is configured to translate the jet engine with respect to the vehicle, rotate the jet with respect to the vehicle, or both; wherein the primary fluid projectile vessel, the secondary fluid projectile vessel, the tertiary fluid projectile vessel, the first nozzle, the second nozzle, the first pump, the second pump, the third pump, the air compressor, or any combination thereof are coupled to the vehicle.

In some embodiments, the primary fluid projectile, the secondary fluid projectile, the tertiary fluid projectile, or any combination thereof comprises water, a surfactant, a flame retardant, a fire protectant, an oxygen depleting chemical, a thermal barrier gel, a crowd dispersal agent, a corrosion inhibitor, a pesticide, a vaccine, a medicine, an oleophilic absorber, snow, ice, water, greywater, an oxygen scavenger, a rheological modifier, a dispersant, a surfactant, or any combination thereof. In some embodiments, the tertiary fluid projectile comprises the surfactant, and wherein the surfactant comprises sodium hydroxide, sodium carbonate, or both. In some embodiments, the tertiary fluid projectile comprises a surfactant, and wherein the surfactant comprises an anionic surfactant, a nonionic surfactant, a cationic surfactant, an amphoteric surfactant, or any combination thereof. In some embodiments, the tertiary fluid projectile comprises a surfactant, and wherein the surfactant comprises castile soap. In some embodiments, the vehicle comprises a car, a truck, a trailer, a tractor, a bus, a minibus, a backhoe, a bulldozer, an excavator, a forwarder, a skidder, a dump truck, a front loader, a logging forwarder, an all-terrain vehicle, or any combination thereof. In some embodiments, the vehicle is autonomous or semi-autonomous. In some embodiments, the vehicle is remote controlled. In some embodiments, the vehicle comprises an operator cabin comprising: a heat shield; a radiation shield; a positive pressure system; an air purifying system; a thermal imaging system; an air conditioning sensor; a chemical sensor; or any combination thereof. In some embodiments, the vehicle comprises a weight distribution system comprising: a support foot; an axle load detector; a bladder; a ballast tank; or any combination thereof. In some embodiments, the vehicle has an outer width of at most about 9 feet. In some embodiments, the jet engine comprises a vector control configured to adjust an angle of the jet-stream with respect to the second end of the gimbal. In some embodiments, the jet engine comprises a nozzle adjusting a cross-sectional shape of the of the jet-stream. In some embodiments, the cross-sectional shape is adjustable. In some embodiments, the platform comprises a single the jet engine. In some embodiments, the platform further comprises a sensor comprising: a GPS sensor; an infrared sensor; a LIDAR sensor; a range finder sensor; or any combination thereof. In some embodiments, the platform further comprises a wireless communication system comprising: a satellite communication system; a cellular communication system; or both. In some embodiments, the platform further comprises a non-transitory computer-readable storage media encoded with a computer program including instructions executable by a processor to direct the gimbal based on a data recorded by the sensor, a data received from the wireless communication system, or both. In some embodiments, the non-transitory computer-readable storage media directs the gimbal using computational fluid dynamics, computer learning, or both. In some embodiments, the vehicle has a carrying capacity of at least about 50,000 pounds. In some embodiments, the vehicle, the jet engine, or both are configured to operate for a period of time of about 12 hours at 60% throttle. In some embodiments, the jet engine is configured to propel the primary fluid projectile at a rate of at least about 500 gallons/minute. In some embodiments, the jet engine is configured to propel the primary fluid projectile at a speed of at least about 50 miles per hour. In some embodiments, the jet engine is configured to propel the primary fluid projectile to a distance of at least about 10 feet.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a block diagram of an exemplary fluid projecting platform, per one or more embodiments herein;

FIG. 2 shows an image of an exemplary fluid projecting platform, per one or more embodiments herein; and

FIG. 3 shows a non-limiting example of a computing device; in this case, a device with one or more processors, memory, storage, and a network interface.

### DETAILED DESCRIPTION

Provided herein is a fluid projecting platform. In some embodiments, the fluid projecting platform herein is configured for use in firefighting, crowd dispersion, agriculture or other related tasks.

### Fluid Projecting Platform

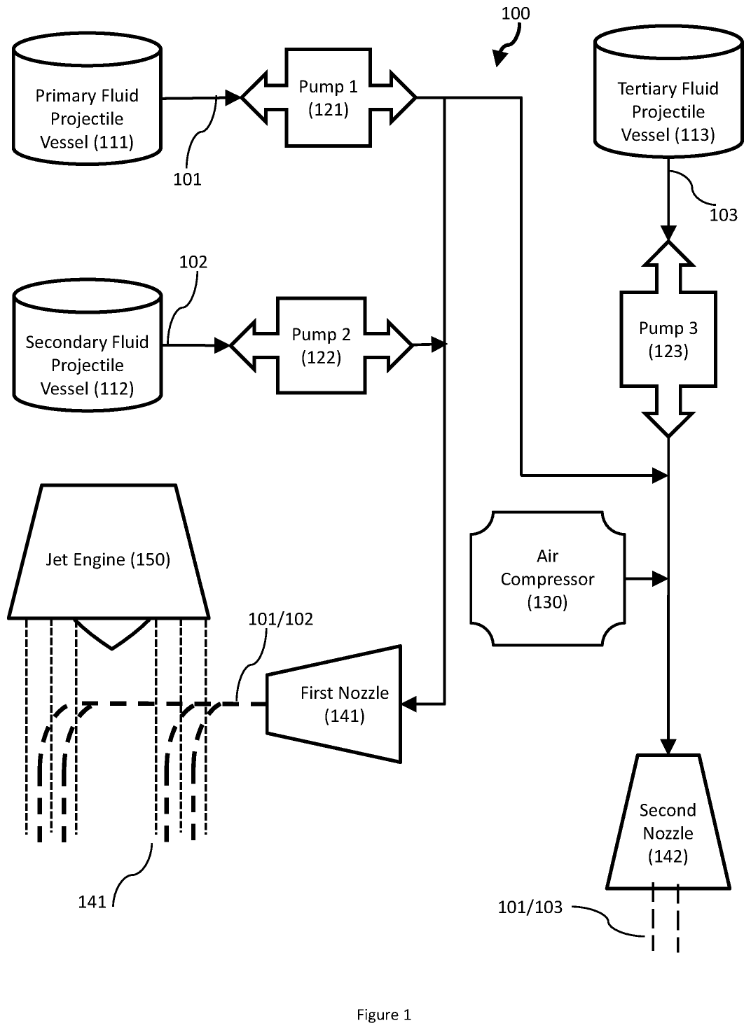

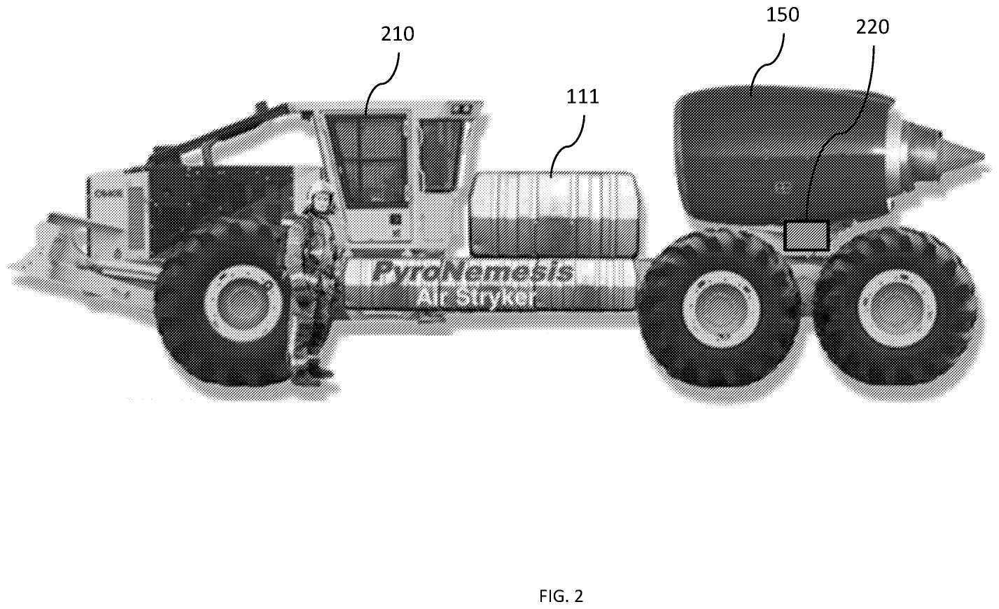

One aspect provided herein, per FIGS. 1-2, is a fluid projecting platform 100. In some embodiments, as shown, the fluid projecting platform 100 comprises: a vehicle; a primary fluid projectile vessel 111 configured to store a primary fluid projectile 101; a secondary fluid projectile vessel 112 configured to store a secondary fluid; a tertiary fluid projectile vessel 113 configured to store a tertiary fluid projectile 103; a first nozzle 141; a second nozzle 142; a first pump 121; a second pump 122; a third pump 123; an air compressor 130; a jet engine 150; a gimbal arm having a first end coupled to the vehicle, and having a second end coupled to the jet engine 150,

In some embodiments, the first pump 121 fluidically transmits the primary fluid projectile 101 to the first nozzle 141. In some embodiments, the second pump 122 fluidically transmits the secondary fluid projectile 102 to the first nozzle 141. In some embodiments, the third pump 123 fluidically transmits the tertiary fluid projectile 103 to the second nozzle 142. In some embodiments, the first nozzle 141, the second nozzle 142, or both comprise a flood nozzle, a raindrop nozzle, a hollow cone nozzle, a full cone nozzle, a flat fan nozzle, a halo nozzle, or any combination thereof.

In some embodiments, the air compressor 130 provides compressed air to the second nozzle 142. In some embodiments, the jet engine 150 emits a jet-stream of a gas in a direction non-coincident with an output of the first nozzle 141. As shown in FIG. 1, the jet engine 150 emits a jet-stream of a gas in a direction perpendicular with an output of the first nozzle 141.

In some embodiments, the primary fluid projectile vessel 111, the secondary fluid projectile vessel 112, the tertiary fluid projectile vessel 113, the first nozzle 141, the second nozzle 142, the first pump 121, the second pump 122, the third pump 123, the air compressor 130, or any combination thereof are coupled to the vehicle. In some embodiments, the primary fluid projectile vessel 111, the secondary fluid projectile vessel 112, the tertiary fluid projectile vessel 113, the first nozzle 141, the second nozzle 142, the first pump 121, the second pump 122, the third pump 123, the air compressor 130, or any combination thereof are removably coupled to the vehicle. In some embodiments, the primary fluid projectile vessel 111, the secondary fluid projectile vessel 112, the tertiary fluid projectile vessel 113, the first nozzle 141, the second nozzle 142, the first pump 121, the second pump 122, the third pump 123, the air compressor 130, or any combination thereof are rigidly coupled to the vehicle. In some embodiments, the primary fluid projectile vessel 111, the secondary fluid projectile vessel 112, the tertiary fluid projectile vessel 113, the first nozzle 141, the second nozzle 142, the first pump 121, the second pump 122, the third pump 123, the air compressor 130, or any combination thereof are flexibly coupled to the vehicle.

In some embodiments, the primary fluid projectile 101, the secondary fluid projectile 102, the tertiary fluid projectile 103, or any combination thereof comprises water, a surfactant, a flame retardant, a fire protectant, an oxygen depleting chemical, a thermal barrier gel, a crowd dispersal agent, a corrosion inhibitor, a pesticide, a vaccine, a medicine, an oleophilic absorber, snow, ice, water, greywater, an oxygen scavenger, a rheological modifier, a dispersant, a surfactant, or any combination thereof. In some embodiments, the tertiary fluid projectile 103 comprises the surfactant, and wherein the surfactant comprises sodium hydroxide, sodium carbonate, or both. In some embodiments, the tertiary fluid projectile 103 comprises a surfactant, and wherein the surfactant comprises an anionic surfactant, a nonionic surfactant, a cationic surfactant, an amphoteric surfactant, or any combination thereof. In some embodiments, the tertiary fluid projectile 103 comprises a surfactant, and wherein the surfactant comprises castile soap.

In some embodiments, the vehicle comprises a car, a truck, a trailer, a tractor, a bus, a minibus, a backhoe, a bulldozer, an excavator, a forwarder, a skidder, a dump truck, a front loader, a logging forwarder, an all-terrain vehicle, or any combination thereof. In some embodiments, the vehicle is human-operated. In some embodiments, the vehicle is autonomous or semi-autonomous. In some embodiments, the vehicle is remote controlled.

In some embodiments, the vehicle comprises an operator cabin comprising: a heat shield; a radiation shield; a positive pressure system; an air purifying system; a thermal imaging system; an air conditioning sensor; a chemical sensor; or any combination thereof. In some embodiments, the heat shield, the radiation shield, the positive pressure system, the air purifying system, the thermal imaging system, the air conditioning sensor, the chemical sensor, or any combination thereof enable an operator to safely drive the vehicle through environments including but not limited to: forest fires, war zones, and deserts. In some embodiments, the vehicle comprises a weight distribution system comprising: a support foot; an axle load detector; a bladder; a ballast tank; or any combination thereof. In some embodiments, the weight distribution system enables the vehicle to operate in a variety of terrains, on stable or unstable ground, in high winds, and on steep slopes. In some embodiments, the weight distribution system ensures stability of the vehicle under forces imparted by the jet engine 150.

In some embodiments, the vehicle has an outer width of at most about 9 feet. In some embodiments, the vehicle has a carrying capacity of at least about 50,000 pounds. In some embodiments, the width, the carrying capacity, or both of the vehicle ensure its ability to maneuver through a wide array of terrains, including but not limited to: city streets, canyons, tunnels, and bridges.

In some embodiments, the jet engine 150 comprises a vector control configured to adjust an angle of the jet-stream with respect to the second end of the gimbal. In some embodiments, the jet engine 150 comprises a nozzle adjusting a cross-sectional shape of the of the jet-stream. In some embodiments, the cross-sectional shape is adjustable. In some embodiments, the platform 100 comprises a single the jet engine 150. In some embodiments, the jet engine 150 comprises a battery, a fuel tank, a fuel pump, or any combination thereof. In some embodiments, the battery, the fuel tank, the fuel pump, or any combination thereof are coupled to the vehicle.

In some embodiments, a jet-stream formed by the jet engine 150 removes tree limbs, sticks, and other flammable materials into an area of already burnt material to form a fire break. In some embodiments, a jet-stream formed by the jet engine 150 cools are around or near flames.

In some embodiments, the jet engine 150 is configured to propel the primary fluid projectile 101 at a rate of about 500 gallons/minute to about 8,000 gallons/minute. In some embodiments, the jet engine 150 is configured to propel the primary fluid projectile 101 at a rate of about 500 gallons/minute to about 1,000 gallons/minute, about 500 gallons/minute to about 2,000 gallons/minute, about 500 gallons/minute to about 3,000 gallons/minute, about 500 gallons/minute to about 4,000 gallons/minute, about 500 gallons/minute to about 5,000 gallons/minute, about 500 gallons/minute to about 6,000 gallons/minute, about 500 gallons/minute to about 7,000 gallons/minute, about 500 gallons/minute to about 8,000 gallons/minute, about 1,000 gallons/minute to about 2,000 gallons/minute, about 1,000 gallons/minute to about 3,000 gallons/minute, about 1,000 gallons/minute to about 4,000 gallons/minute, about 1,000 gallons/minute to about 5,000 gallons/minute, about 1,000 gallons/minute to about 6,000 gallons/minute, about 1,000 gallons/minute to about 7,000 gallons/minute, about 1,000 gallons/minute to about 8,000 gallons/minute, about 2,000 gallons/minute to about 3,000 gallons/minute, about 2,000 gallons/minute to about 4,000 gallons/minute, about 2,000 gallons/minute to about 5,000 gallons/minute, about 2,000 gallons/minute to about 6,000 gallons/minute, about 2,000 gallons/minute to about 7,000 gallons/minute, about 2,000 gallons/minute to about 8,000 gallons/minute, about 3,000 gallons/minute to about 4,000 gallons/minute, about 3,000 gallons/minute to about 5,000 gallons/minute, about 3,000 gallons/minute to about 6,000 gallons/minute, about 3,000 gallons/minute to about 7,000 gallons/minute, about 3,000 gallons/minute to about 8,000 gallons/minute, about 4,000 gallons/minute to about 5,000 gallons/minute, about 4,000 gallons/minute to about 6,000 gallons/minute, about 4,000 gallons/minute to about 7,000 gallons/minute, about 4,000 gallons/minute to about 8,000 gallons/minute, about 5,000 gallons/minute to about 6,000 gallons/minute, about 5,000 gallons/minute to about 7,000 gallons/minute, about 5,000 gallons/minute to about 8,000 gallons/minute, about 6,000 gallons/minute to about 7,000 gallons/minute, about 6,000 gallons/minute to about 8,000 gallons/minute, or about 7,000 gallons/minute to about 8,000 gallons/minute, including increments therein. In some embodiments, the jet engine 150 is configured to propel the primary fluid projectile 101 at a rate of about 500 gallons/minute, about 1,000 gallons/minute, about 2,000 gallons/minute, about 3,000 gallons/minute, about 4,000 gallons/minute, about 5,000 gallons/minute, about 6,000 gallons/minute, about 7,000 gallons/minute, or about 8,000 gallons/minute. In some embodiments, the jet engine 150 is configured to propel the primary fluid projectile 101 at a rate of at least about 500 gallons/minute, about 1,000 gallons/minute, about 2,000 gallons/minute, about 3,000 gallons/minute, about 4,000 gallons/minute, about 5,000 gallons/minute, about 6,000 gallons/minute, or about 7,000 gallons/minute. In some embodiments, the jet engine 150 is configured to propel the primary fluid projectile 101 at a rate of at most about 1,000 gallons/minute, about 2,000 gallons/minute, about 3,000 gallons/minute, about 4,000 gallons/minute, about 5,000 gallons/minute, about 6,000 gallons/minute, about 7,000 gallons/minute, or about 8,000 gallons/minute.

In some embodiments, the jet engine 150 is configured to propel the primary fluid projectile 101 at a speed of about 50 mph (miles per hour) to about 500 mph. In some embodiments, the jet engine 150 is configured to propel the primary fluid projectile 101 at a speed of about 50 mph to about 75 mph, about 50 mph to about 100 mph, about 50 mph to about 125 mph, about 50 mph to about 150 mph, about 50 mph to about 175 mph, about 50 mph to about 200 mph, about 50 mph to about 225 mph, about 50 mph to about 250 mph, about 50 mph to about 300 mph, about 50 mph to about 400 mph, about 50 mph to about 500 mph, about 75 mph to about 100 mph, about 75 mph to about 125 mph, about 75 mph to about 150 mph, about 75 mph to about 175 mph, about 75 mph to about 200 mph, about 75 mph to about 225 mph, about 75 mph to about 250 mph, about 75 mph to about 300 mph, about 75 mph to about 400 mph, about 75 mph to about 500 mph, about 100 mph to about 125 mph, about 100 mph to about 150 mph, about 100 mph to about 175 mph, about 100 mph to about 200 mph, about 100 mph to about 225 mph, about 100 mph to about 250 mph, about 100 mph to about 300 mph, about 100 mph to about 400 mph, about 100 mph to about 500 mph, about 125 mph to about 150 mph, about 125 mph to about 175 mph, about 125 mph to about 200 mph, about 125 mph to about 225 mph, about 125 mph to about 250 mph, about 125 mph to about 300 mph, about 125 mph to about 400 mph, about 125 mph to about 500 mph, about 150 mph to about 175 mph, about 150 mph to about 200 mph, about 150 mph to about 225 mph, about 150 mph to about 250 mph, about 150 mph to about 300 mph, about 150 mph to about 400 mph, about 150 mph to about 500 mph, about 175 mph to about 200 mph, about 175 mph to about 225 mph, about 175 mph to about 250 mph, about 175 mph to about 300 mph, about 175 mph to about 400 mph, about 175 mph to about 500 mph, about 200 mph to about 225 mph, about 200 mph to about 250 mph, about 200 mph to about 300 mph, about 200 mph to about 400 mph, about 200 mph to about 500 mph, about 225 mph to about 250 mph, about 225 mph to about 300 mph, about 225 mph to about 400 mph, about 225 mph to about 500 mph, about 250 mph to about 300 mph, about 250 mph to about 400 mph, about 250 mph to about 500 mph, about 300 mph to about 400 mph, about 300 mph to about 500 mph, or about 400 mph to about 500 mph, including increments therein. In some embodiments, the jet engine 150 is configured to propel the primary fluid projectile 101 at a speed of about 50 mph, about 75 mph, about 100 mph, about 125 mph, about 150 mph, about 175 mph, about 200 mph, about 225 mph, about 250 mph, about 300 mph, about 400 mph, or about 500 mph. In some embodiments, the jet engine 150 is configured to propel the primary fluid projectile 101 at a speed of at least about 50 mph, about 75 mph, about 100 mph, about 125 mph, about 150 mph, about 175 mph, about 200 mph, about 225 mph, about 250 mph, about 300 mph, or about 400 mph. In some embodiments, the jet engine 150 is configured to propel the primary fluid projectile 101 at a speed of at most about 75 mph, about 100 mph, about 125 mph, about 150 mph, about 175 mph, about 200 mph, about 225 mph, about 250 mph, about 300 mph, about 400 mph, or about 500 mph.

In some embodiments, the jet engine 150 is configured to propel the primary fluid projectile 101 to a distance of about 10 ft to about 800 ft. In some embodiments, the jet engine 150 is configured to propel the primary fluid projectile 101 to a distance of about 10 ft to about 20 ft, about 10 ft to about 50 ft, about 10 ft to about 100 ft, about 10 ft to about 200 ft, about 10 ft to about 300 ft, about 10 ft to about 400 ft, about 10 ft to about 500 ft, about 10 ft to about 600 ft, about 10 ft to about 700 ft, about 10 ft to about 800 ft, about 20 ft to about 50 ft, about 20 ft to about 100 ft, about 20 ft to about 200 ft, about 20 ft to about 300 ft, about 20 ft to about 400 ft, about 20 ft to about 500 ft, about 20 ft to about 600 ft, about 20 ft to about 700 ft, about 20 ft to about 800 ft, about 50 ft to about 100 ft, about 50 ft to about 200 ft, about 50 ft to about 300 ft, about 50 ft to about 400 ft, about 50 ft to about 500 ft, about 50 ft to about 600 ft, about 50 ft to about 700 ft, about 50 ft to about 800 ft, about 100 ft to about 200 ft, about 100 ft to about 300 ft, about 100 ft to about 400 ft, about 100 ft to about 500 ft, about 100 ft to about 600 ft, about 100 ft to about 700 ft, about 100 ft to about 800 ft, about 200 ft to about 300 ft, about 200 ft to about 400 ft, about 200 ft to about 500 ft, about 200 ft to about 600 ft, about 200 ft to about 700 ft, about 200 ft to about 800 ft, about 300 ft to about 400 ft, about 300 ft to about 500 ft, about 300 ft to about 600 ft, about 300 ft to about 700 ft, about 300 ft to about 800 ft, about 400 ft to about 500 ft, about 400 ft to about 600 ft, about 400 ft to about 700 ft, about 400 ft to about 800 ft, about 500 ft to about 600 ft, about 500 ft to about 700 ft, about 500 ft to about 800 ft, about 600 ft to about 700 ft, about 600 ft to about 800 ft, or about 700 ft to about 800 ft, including increments therein. In some embodiments, the jet engine 150 is configured to propel the primary fluid projectile 101 to a distance of about 10 ft, about 20 ft, about 50 ft, about 100 ft, about 200 ft, about 300 ft, about 400 ft, about 500 ft, about 600 ft, about 700 ft, or about 800 ft. In some embodiments, the jet engine 150 is configured to propel the primary fluid projectile 101 to a distance of at least about 10 ft, about 20 ft, about 50 ft, about 100 ft, about 200 ft, about 300 ft, about 400 ft, about 500 ft, about 600 ft, or about 700 ft. In some embodiments, the jet engine 150 is configured to propel the primary fluid projectile 101 to a distance of at most about 20 ft, about 50 ft, about 100 ft, about 200 ft, about 300 ft, about 400 ft, about 500 ft, about 600 ft, about 700 ft, or about 800 ft.

In some embodiments, the vehicle, the jet engine 150, or both are configured to operate for a period of time of about 12 hours at 60% throttle. In some embodiments, the vehicle, the jet engine 150, or both are configured to operate for a period of time of about 6 hours to about 24 hours. In some embodiments, the vehicle, the jet engine 150, or both are configured to operate for a period of time of about 6 hours to about 8 hours, about 6 hours to about 10 hours, about 6 hours to about 12 hours, about 6 hours to about 14 hours, about 6 hours to about 16 hours, about 6 hours to about 18 hours, about 6 hours to about 20 hours, about 6 hours to about 22 hours, about 6 hours to about 24 hours, about 8 hours to about 10 hours, about 8 hours to about 12 hours, about 8 hours to about 14 hours, about 8 hours to about 16 hours, about 8 hours to about 18 hours, about 8 hours to about 20 hours, about 8 hours to about 22 hours, about 8 hours to about 24 hours, about 10 hours to about 12 hours, about 10 hours to about 14 hours, about 10 hours to about 16 hours, about 10 hours to about 18 hours, about 10 hours to about 20 hours, about 10 hours to about 22 hours, about 10 hours to about 24 hours, about 12 hours to about 14 hours, about 12 hours to about 16 hours, about 12 hours to about 18 hours, about 12 hours to about 20 hours, about 12 hours to about 22 hours, about 12 hours to about 24 hours, about 14 hours to about 16 hours, about 14 hours to about 18 hours, about 14 hours to about 20 hours, about 14 hours to about 22 hours, about 14 hours to about 24 hours, about 16 hours to about 18 hours, about 16 hours to about 20 hours, about 16 hours to about 22 hours, about 16 hours to about 24 hours, about 18 hours to about 20 hours, about 18 hours to about 22 hours, about 18 hours to about 24 hours, about 20 hours to about 22 hours, about 20 hours to about 24 hours, or about 22 hours to about 24 hours, including increments therein. In some embodiments, the vehicle, the jet engine 150, or both are configured to operate for a period of time of about 6 hours, about 8 hours, about 10 hours, about 12 hours, about 14 hours, about 16 hours, about 18 hours, about 20 hours, about 22 hours, or about 24 hours. In some embodiments, the vehicle, the jet engine 150, or both are configured to operate for a period of time of at least about 6 hours, about 8 hours, about 10 hours, about 12 hours, about 14 hours, about 16 hours, about 18 hours, about 20 hours, or about 22 hours. In some embodiments, the vehicle, the jet engine 150, or both are configured to operate for a period of time of at most about 8 hours, about 10 hours, about 12 hours, about 14 hours, about 16 hours, about 18 hours, about 20 hours, about 22 hours, or about 24 hours.

In some embodiments, the platform 100 further comprises a sensor comprising: a GPS sensor; an infrared sensor; a LIDAR sensor; a range finder sensor; or any combination thereof. In some embodiments, the platform 100 further comprises a wireless communication system comprising: a satellite communication system; a cellular communication system; or both. In some embodiments, the platform 100 further comprises a non-transitory computer-readable storage media encoded with a computer program including instructions executable by a processor to direct the gimbal based on a data recorded by the sensor, a data received from the wireless communication system, or both. In some embodiments, the non-transitory computer-readable storage media directs the gimbal using computational fluid dynamics, computer learning, or both.

### Additional Embodiments

This disclosure relates to a novel method/system to contain, penetrate, and extinguish fires in forests and remote areas with brush or wooded lots, by joining the power of a jet engine (or similarly acting magnifier/director of airflow) with the extreme mobility of a high capacity logging vehicle. A logging “forwarder” or “skidder” is a tracked/wheeled all-terrain vehicle designed for use in mountainous areas, remote hills, and marsh zones. It has the weight to offset the recoil of the rapid effluence of jet exhaust, the load capacity to carry a high volume of firefighting and structure-protecting fluids, and the ability to traverse and access terrain that is inaccessible to conventional fire trucks, including conventional brush trucks.

The high volume, pressure and speed of the jet exhaust physically scrapes and moves flammable materials into the burned zone, creating a fire break. It disrupts the fire, breaks burning limbs off and throws them back into the burned area. It strips heat and cools the chemical reaction that creates the flames. It forces advancing flames back onto the area which had already been burned over. A component of the disclosure injects and/or educts water and/or other chemicals into the high speed air exiting the jet, directing them as needed to stop the advance of the fire.

Described herein is a high mobility, all-wheel drive, all weather firefighting vehicle capable of operation in extreme conditions, and has capacities including remote controlled insertion into fully engulfed forest fires, fuel storage tank farms, refineries, port/rail yards, gas/oil pumping stations, storage/silo, and nuclear disaster areas.

The disclosure provides a platform for suppressing fire, heat, smoke, and airborne particulates/contaminants resulting from natural and man-made disasters. In some embodiments, the platforms herein quickly apply a broad range of chemistries over large areas and distances, making it also a powerful tool for remediation of oil spills, hazmat spills, and cleanup of nuclear, biological, and chemical situations.

The present disclosure pertains to methods of fighting forest fires and other techniques for fighting forest fires and other techniques for environmental restoration of damaged terrains and buildings. The core aspect of the disclosure centers on the delivery system and its diverse capabilities. The modification of existing logging equipment serves as a platform for mobile rapid response vehicles. Forwarders and skidders are used daily in rough remote forests to remove logs and grade trails for access and removal of timber. Forwarders have an existing hydraulic system adequately used for agile movements of its lifting boom, plow, winch, and attachable accessories. Forwarders and skidders are fueled by diesel and are adaptable to utilizing bio diesel, a methyl ester soy based eco-friendly biofuel. Additionally, new safer emulsified fuel technology (EFT) can be utilized as a clean burning safer fuel.

The multi positional hydraulic boom is adaptable to modification for firefighting and may support a coupling to a jet, a cutter/feller, an air duct, a fluid delivery nozzle, or another attachment useful in combating fire.

A key benefit of the methods/systems of the present disclosure is fire suppression via rapid dispersal airborne aqueous compounds such as an oxygen scavenging water admixture. In some embodiments, the airborne aqueous compound functionalizes greywater as a wet or vaporized water cloud to cool/blanket open flame. In some embodiments, the airborne aqueous compound provides efficient rheological modification to water as a dispersed extinguishment aid. As a dispersant bio based agent, Fire Out also serves as a foam booster for a protein and surfactant based dense foams. Fire Out rapidly blends in high Ph waste/pond water and salt water. In some embodiments, the airborne aqueous compound comprises an in-situ rheological aid for high shear water streams. Thickened/bodied water functions as a hydro gelled aqueous medium for longer term coverage of smoldering debris. As a coalescent chemistry, the airborne aqueous compound provides longer duration/saturation as a bound water nano encapsulant to reduce water consumption.

In some embodiments, the airborne aqueous compound comprises a nutrient based fertilizer/seed germinator for revegetation, hydro-seeding, and soil amendment. As a restorative, the airborne aqueous compound functions as a binder/stimulant. In some embodiments, the airborne aqueous compound is a fluid applied natural emulsion utilizing odorless fish emulsions and enzymes.

Modular assembly for replacement of either the body, the tanks, or the jet. Rather than an entire unit being out of service while repairs are made, modules could be swapped, including exchanging empty tanks for full ones, to keep the equipment in use and online. Pivoting gimbal mount allows movement of the jet or jet array, so that the jet can face the fire while the vehicle advances parallel to the fire line. GPS and satellite communication equipped for connected positioning and communication in remote areas, interaction with other units, resources, and command structure. Infrared and other heat detecting sensors to determine temperature profiles within a fire zone. Autonomous capabilities that allow for unmanned attack of fires based on IR profiles or other mathematical formulas. Incorporation of advanced artificial intelligence (AI) to enhance capabilities. Interface with existing fire detection capabilities in aircraft. Sensors for data collection to enhance computational fluid dynamics (CFD) to enable better predictive modelling of current and future fires. Interface between CFD, AI and autonomous capabilities to inform optimal efficiency for positioning and delivery of dispersed agents. New innovative emitters, delivery technologies to apply structure-enveloping fire stopping barriers and thermal protection barriers. The vehicle weighs approximately 60,000 pounds (27,000 Kilograms) and can carry an additional 40,000 pounds (18,000 Kilograms) of deliverable fluids and granular solids. The jet engine can deliver air flows in excess of 250 mph at 10 feet, (400 kph at 3 meters) 150 mph at 150 feet, (240 kph at 46 meters) and of 100 mph at 470 feet (160 kph at 146 meters). This is sufficient to strip grass, brush, small trees, debris, and loose soil from the ground, quickly creating an effective fire break. The platform herein could be equipped with a laser/lidar/optical rangefinder to help the pilot determine the proper throttle setting for removing fuel load and treating surfaces without causing damage to structures. The jet effluent nozzle may be equipped with deflectors that allow for controlling the width of airstream, from high pressure narrow for digging and clearing, to wide flow for broad distribution of additives. The vehicle may be equipped with axle based load detectors, and pitch, roll and yaw sensors to maintain ground stability and auto-throttle and direct the jet in order to eliminate jet induced roll-over. Ballast bladders could optimize the position of deliverable fluids within the tanks to maximize thrust potential from the jet without flipping the vehicle. The entire rig and it's accessories may be protected by a 3″ hardened steel pipe roll cage. The types of hose connection from the tanks to the jet engine and nozzles are suitably protected from fire or other hazards as are necessary. The onboard fuel tanks could operate both the base vehicle and the jet engine for 12 hours at 60% throttle. Smart controls with sensors monitor the wind and/or water mist density to optimize fire knock down and area cooling. The same smart delivery system monitors the delivery of protective gels to save buildings, and of foam quality to protect vegetation. Thermal sensors could detect heat coming from structures and determine when a structure has been sufficiently insulated with gels. Pumps and educators deliver liquid and granular solids to the jet nozzle for airborne delivery to the target surfaces. Satellite telemetry enabled sensors on the vehicle could relay data about fire conditions (wind speed, wind direction, humidity, temperature, barometric pressure) to incident command in real-time to enable greater fire date to improve decision making. Operators are protected by a heat shield around the cabin, and by a positive pressure purified air system to protect against both biological and hazardous chemical respiratory exposure. A Scott Pak compliant operator's seat, like those used on fire trucks, allows the pilot to wear a Scott Pak while piloting the craft, in case of need for bailout in smoky conditions. Overhead and 360 degree obstacle warning sensors alert the pilot to obstacles, and can be set to override steering and braking controls to protect against collisions. A heavy duty gimbal controls the direction of the jet, and automatically tilts the jet upward to prevent rollover if axle weight sensors and attitude controls determine that a rollover is imminent. Mission autonomy using cameras, radar and thermal sensors could allow the platform herein to “seek and destroy” hotspots without a pilot, or via remote control. 360 degree thermal imaging cameras and monitors allow the pilot to see through smoke, detect hotspots, determine fire temperature, and determine safe escape routes for both the vehicle and nearby firefighters. The thermal imaging system is tied to the onboard operations computer to detect and avoid directing the jet at firefighters. The vehicle can be refueled with all onboard liquids without interrupting operations. High floatation tires allow access to virtually all terrains, with minimal impact. The jet engine, it's gimbal mount and the necessary tanks for jet fuel and dispersed agents can be modularly affixed to the base vehicle such that the “business end’ of the disclosure can be swapped out expeditiously, or mounted to another type of base transport vehicle, such as a boat or trailer. What is claimed is a rapid deployment firefighting apparatus for insertion in rough/steep terrains for firefighting and other security related applications such as crowd/riot control, border interdiction, and defensive uses.

Provided herein is: a firefighting apparatus that combines a jet engine, or similarly powerful source of high-speed, high-pressure, high volume air flow, flexibly secured to an all-terrain high load capacity vehicle; a platform of carrying large volumes of jet fuel, water, fire retardant or other chemistries with the apparatus to make it effective and efficient; a platform of providing for injection of water fire retardant or other chemistries into the exhaust stream of the jet engine; and a shielded thermally protected insulated firefighting apparatus designed to reduce radiant heat transfer. New thermal barrier media provides heat shielding protection to operators of the equipment; A platform of providing for injection into the air out flow of the turbine jet engine, water, or other fire retardant substances; a platform of carrying sufficiently large quantities of jet fuel, water, or other fire retardant materials with the firefighting apparatus to make it effective and efficient; a platform to pivot the jet engine to direct the exhaust from the jet engine as needed towards the target zone to provide air at high volume, pressure, and speed, alone or combined with water or other chemical agents to saturate and extinguish burning materials in front of and within advancing fire, and a method of spreading or narrowing the jet effluent, as needed for various tasks, objectives, and operational areas.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### Computing Systems

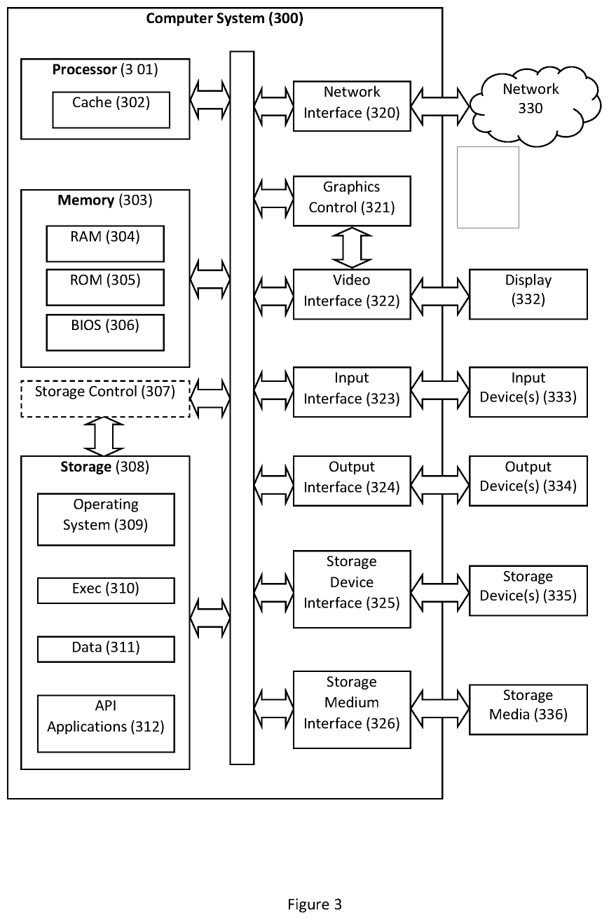

Referring to FIG. 3, a block diagram is shown depicting an exemplary machine that includes a computer system 300 (e.g., a processing or computing system) within which a set of instructions can execute for causing a device to perform or execute any one or more of the aspects and/or methodologies for static code scheduling of the present disclosure. The components in FIG. 3 are examples only and do not limit the scope of use or functionality of any hardware, software, embedded logic component, or a combination of two or more such components implementing particular embodiments.

Computer system 300 may include one or more processors 301, a memory 303, and a storage 308 that communicate with each other, and with other components, via a bus 340. The bus 340 may also link a display 332, one or more input devices 333 (which may, for example, include a keypad, a keyboard, a mouse, a stylus, etc.), one or more output devices 334, one or more storage devices 335, and various tangible storage media 336. All of these elements may interface directly or via one or more interfaces or adaptors to the bus 340. For instance, the various tangible storage media 336 can interface with the bus 340 via storage medium interface 326. Computer system 300 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 300 includes one or more processor(s) 301 (e.g., central processing units (CPUs) or general purpose graphics processing units (GPGPUs)) that carry out functions. Processor(s) 301 optionally contains a cache memory unit 302 for temporary local storage of instructions, data, or computer addresses. Processor(s) 301 are configured to assist in execution of computer readable instructions. Computer system 300 may provide functionality for the components depicted in FIG. 3 as a result of the processor(s) 301 executing non-transitory, processor-executable instructions embodied in one or more tangible computer-readable storage media, such as memory 303, storage 308, storage devices 335, and/or storage medium 336. The computer-readable media may store software that implements particular embodiments, and processor(s) 301 may execute the software. Memory 303 may read the software from one or more other computer-readable media (such as mass storage device(s) 335, 336) or from one or more other sources through a suitable interface, such as network interface 320. The software may cause processor(s) 301 to carry out one or more processes or one or more steps of one or more processes described or illustrated herein. Carrying out such processes or steps may include defining data structures stored in memory 303 and modifying the data structures as directed by the software.

The memory 303 may include various components (e.g., machine readable media) including, but not limited to, a random access memory component (e.g., RAM 304) (e.g., static RAM (SRAM), dynamic RAM (DRAM), ferroelectric random access memory (FRAM), phase-change random access memory (PRAM), etc.), a read-only memory component (e.g., ROM 305), and any combinations thereof. ROM 305 may act to communicate data and instructions unidirectionally to processor(s) 301, and RAM 304 may act to communicate data and instructions bidirectionally with processor(s) 301. ROM 305 and RAM 304 may include any suitable tangible computer-readable media described below. In one example, a basic input/output system 306 (BIOS), including basic routines that help to transfer information between elements within computer system 300, such as during start-up, may be stored in the memory 303.

Fixed storage 308 is connected bidirectionally to processor(s) 301, optionally through storage control unit 307. Fixed storage 308 provides additional data storage capacity and may also include any suitable tangible computer-readable media described herein. Storage 308 may be used to store operating system 309, executable(s) 310, data 311, applications 312 (application programs), and the like. Storage 308 can also include an optical disk drive, a solid-state memory device (e.g., flash-based systems), or a combination of any of the above. Information in storage 308 may, in appropriate cases, be incorporated as virtual memory in memory 303.

In one example, storage device(s) 335 may be removably interfaced with computer system 300 (e.g., via an external port connector (not shown)) via a storage device interface 325. Particularly, storage device(s) 335 and an associated machine-readable medium may provide non-volatile and/or volatile storage of machine-readable instructions, data structures, program modules, and/or other data for the computer system 300. In one example, software may reside, completely or partially, within a machine-readable medium on storage device(s) 335. In another example, software may reside, completely or partially, within processor(s) 301.

Bus 340 connects a wide variety of subsystems. Herein, reference to a bus may encompass one or more digital signal lines serving a common function, where appropriate. Bus 340 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 300 may also include an input device 333. In one example, a user of computer system 300 may enter commands and/or other information into computer system 300 via input device(s) 333. Examples of an input device(s) 333 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 333 may be interfaced to bus 340 via any of a variety of input interfaces 323 (e.g., input interface 323) including, but not limited to, serial, parallel, game port, USB, FIREWIRE, THUNDERBOLT, or any combination of the above.

In particular embodiments, when computer system 300 is connected to network 330, computer system 300 may communicate with other devices, specifically mobile devices and enterprise systems, distributed computing systems, cloud storage systems, cloud computing systems, and the like, connected to network 330. Communications to and from computer system 300 may be sent through network interface 320. For example, network interface 320 may receive incoming communications (such as requests or responses from other devices) in the form of one or more packets (such as Internet Protocol (IP) packets) from network 330, and computer system 300 may store the incoming communications in memory 303 for processing. Computer system 300 may similarly store outgoing communications (such as requests or responses to other devices) in the form of one or more packets in memory 303 and communicated to network 330 from network interface 320. Processor(s) 301 may access these communication packets stored in memory 303 for processing.

Examples of the network interface 320 include, but are not limited to, a network interface card, a modem, and any combination thereof. Examples of a network 330 or network segment 330 include, but are not limited to, a distributed computing system, a cloud computing system, a wide area network (WAN) (e.g., the Internet, an enterprise network), a local area network (LAN) (e.g., a network associated with an office, a building, a campus, or other relatively small geographic space), a telephone network, a direct connection between two computing devices, a peer-to-peer network, and any combinations thereof. A network, such as network 330, may employ a wired and/or a wireless mode of communication. In general, any network topology may be used.

Information and data can be displayed through a display 332. Examples of a display 332 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 332 can interface to the processor(s) 301, memory 303, and fixed storage 308, as well as other devices, such as input device(s) 333, via the bus 340. The display 332 is linked to the bus 340 via a video interface 322, and transport of data between the display 332 and the bus 340 can be controlled via the graphics control 321. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 332, computer system 300 may include one or more other peripheral output devices 334 including, but not limited to, an audio speaker, a printer, a storage device, and any combinations thereof. Such peripheral output devices may be connected to the bus 340 via an output interface 324. Examples of an output interface 324 include, but are not limited to, a serial port, a parallel connection, a USB port, a FIREWIRE port, a THUNDERBOLT port, and any combinations thereof.

In addition or as an alternative, computer system 300 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3@, Sony® PS4®, Microsoft® Xbox 360@, Microsoft Xbox One, Nintendo® Wii®, Nintendo® Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

1. A fluid projecting platform comprising:
(a) a vehicle;
(b) a primary fluid projectile vessel configured to store a primary fluid projectile;
(c) a secondary fluid projectile vessel configured to store a secondary fluid;
(d) a tertiary fluid projectile vessel configured to store a tertiary fluid projectile;
(e) a first nozzle;
(f) a second nozzle;
(g) a first pump fluidically transmitting the primary fluid projectile to the first nozzle;
(h) a second pump fluidically transmitting the secondary fluid projectile to the first nozzle;
(i) a third pump fluidically transmitting the tertiary fluid projectile to the second nozzle;
(j) an air compressor providing compressed air to the second nozzle;
(k) a jet engine emitting a jet-stream of a gas in a direction non-coincident with an output of the first nozzle;
(l) a gimbal arm having a first end coupled to the vehicle, and having a second end coupled to the jet engine, wherein the gimbal arm is configured to translate the jet engine with respect to the vehicle, rotate the jet with respect to the vehicle, or both;
wherein the primary fluid projectile vessel, the secondary fluid projectile vessel, the tertiary fluid projectile vessel, the first nozzle, the second nozzle, the first pump, the second pump, the third pump, the air compressor, or any combination thereof are coupled to the vehicle.

2. The platform of claim 1, wherein the primary fluid projectile, the secondary fluid projectile, the tertiary fluid projectile, or any combination thereof comprises water, a surfactant, a flame retardant, a fire protectant, an oxygen depleting chemical, a thermal barrier gel, a crowd dispersal agent, a corrosion inhibitor, a pesticide, a vaccine, a medicine, an oleophilic absorber, snow, ice, water, greywater, an oxygen scavenger, a rheological modifier, a dispersant, a surfactant, or any combination thereof.

3. The platform of claim 2, wherein the tertiary fluid projectile comprises the surfactant, and wherein the surfactant comprises sodium hydroxide, sodium carbonate, or both.

4. The platform of claim 2, wherein the tertiary fluid projectile comprises a surfactant, and wherein the surfactant comprises an anionic surfactant, a nonionic surfactant, a cationic surfactant, an amphoteric surfactant, or any combination thereof.

5. The platform of claim 2, wherein the tertiary fluid projectile comprises a surfactant, and wherein the surfactant comprises castile soap.

6. The platform of claim 1, wherein the vehicle comprises a car, a truck, a trailer, a tractor, a bus, a minibus, a backhoe, a bulldozer, an excavator, a forwarder, a skidder, a dump truck, a front loader, a logging forwarder, an all-terrain vehicle, or any combination thereof.

7. The platform of claim 1, wherein the vehicle is autonomous or semi-autonomous.

8. The platform of claim 1, wherein the vehicle is remote controlled.

9. The platform of claim 1, wherein the vehicle comprises an operator cabin comprising:
(a) a heat shield;
(b) a radiation shield;
(c) a positive pressure system;
(d) an air purifying system;
(e) a thermal imaging system;
(f) an air conditioning sensor;
(g) a chemical sensor; or
(h) any combination thereof.

10. The platform of claim 1, wherein the vehicle comprises a weight distribution system comprising:
(a) a support foot;
(b) an axle load detector;
(c) a bladder;
(d) a ballast tank; or
(e) any combination thereof.

11. The platform of claim 1, wherein the vehicle has an outer width of at most about 9 feet.

12. The platform of claim 1, wherein the jet engine comprises a vector control configured to adjust an angle of the j et-stream with respect to the second end of the gimbal.

13. The platform of claim 1, wherein the jet engine comprises a nozzle adjusting a cross-sectional shape of the of the jet-stream.

14. The platform of claim 13, wherein the cross-sectional shape is adjustable.

15. The platform of claim 1, comprising a single the jet engine.

16. The platform of claim 1 further comprising a sensor comprising:
(a) a GPS sensor;
(b) an infrared sensor;
(c) a LIDAR sensor;
(d) a range finder sensor; or
(e) any combination thereof.

17. The platform of claim 16, further comprising a wireless communication system comprising:
(a) a satellite communication system;
(b) a cellular communication system; or
(c) both.

18. The platform of claim 16, further comprising a non-transitory computer-readable storage media encoded with a computer program including instructions executable by a processor to direct the gimbal based on a data recorded by the sensor, a data received from the wireless communication system, or both.

19. The platform of claim 18, wherein the non-transitory computer-readable storage media directs the gimbal using computational fluid dynamics, computer learning, or both.

20. The platform of claim 1, wherein the vehicle has a carrying capacity of at least about 50,000 pounds.

21. The platform of claim 1, wherein the vehicle, the jet engine, or both are configured to operate for a period of time of about 12 hours at 60% throttle.

22. The platform of claim 1, wherein the jet engine is configured to propel the primary fluid projectile at a rate of at least about 500 gallons/minute.

23. The platform of claim 1, wherein the jet engine is configured to propel the primary fluid projectile at a speed of at least about 50 miles per hour.

24. The platform of claim 1, wherein the jet engine is configured to propel the primary fluid projectile to a distance of at least about 10 feet.
